(19) United States
(12) Patent Application Publication
(10) Pub. No.: US 2015/0206483 A1
(43) Pub. Date: Jul. 23, 2015

(54) BACKLIGHT CONTROL METHOD FOR AN ELECTRONIC MOBILE DEVICE

(71) Applicant: Sony Corporation, Tokyo (JP)

(72) Inventor: Valter Hesselmark, Lund (SE)

(21) Appl. No.: 14/383,930

(22) PCT Filed: Dec. 24, 2013
(86) PCT No.: PCT/IB2013/061305

§ 371 Date: Sep. 9, 2014

(51) Int. Cl. G09G 3/34; G06K 9/46; G09G 5/10

(52) U.S. Cl. CPC G09G 3/3406; G09G 5/10; G06K 9/4642

(57) ABSTRACT

Provided is a method of Content Adaptive Backlight Control (CABC) for use in an electronic mobile device for improving a quality of an image. The electronic mobile device comprises at least one display i.e. a Liquid Crystal Display (LCD) for showing the image. The content of the image is shown on the display by a plurality of pixels. The electronic mobile device is adapted to establish a light level of light being ambient of the electronic mobile device, and to stretch a histogram of the image whereby a part of the plurality of pixels is brought into saturation. When the ambient light level is below a first threshold, the stretching of the histogram is decreased, whereby the part of the plurality of pixels brought into saturation is decreased and the quality of the image is improved.

### TECHNICAL FIELD

Embodiments herein relate to methods for improving a quality of an image. Other embodiments herein relate to an electronic mobile device adapted for improving a quality of an image.

### BACKGROUND

Power consumption is a very important characteristic for electronic mobile devices. Since Liquid Crystal Display (LCD) displays that often are used in electronic mobile devices, becomes larger and larger, have more saturated colors and higher resolution, the consumption of the backlight of the display has increased in a quick rate. Reduction in current consumption is therefore desired. One way to achieve reduction of current consumption is to use Content Adaptive Backlight Control (CABC). The content of an image is shown on a display by a plurality of pixels, given values between 0-255 from dark to bright. When applying CABC, the histogram of the display content is stretched. Thus, by manipulating the image the full range of the LCD display is utilized, using pixels given a value from zero to 255. Thus, the brightest pixels in an image may become saturated. Simultaneously, the backlight luminance of the display is dimmed in the same rate as the histogram is stretched. By lowering the backlight luminance of the display in this way, the result will be lower current consumption and basically the same image quality on the display. By stretching the image, the image becomes brighter; however, by lowering the backlight luminance the image becomes darker. Thus, the experience when observing the image will be that the quality of the image is maintained. However, the quality of the image is not fully satisfying.

### SUMMARY

An object of embodiments herein is to provide a way for a method for an electronic mobile device to improve a quality of an image.

According to a first aspect of embodiments herein, the object is achieved by a method in an electronic mobile device. The electronic mobile device comprises at least one display for showing the image. The content of an image is shown on the display by a plurality of pixels. The electronic mobile device establishes a light level of light being ambient of the electronic mobile device. The electronic mobile device then stretches a histogram of the image, whereby a part of the plurality of pixels is brought into saturation. When the ambient light level is below a first threshold, the electronic mobile device decreases the stretching of the histogram, whereby the part of the plurality of pixels brought into saturation is decreased and the quality of the image is improved.

According to a second aspect of embodiments herein, the object is achieved by an electronic mobile device adapted for improving a quality of an image, and comprising at least one display for showing the image. The content of an image is shown on the display by a plurality of pixels. The electronic mobile device comprises at least one ambient light level sensor, ALS, adapted to establish a light level of light being ambient of the electronic mobile device. The electronic mobile device further comprises at least one Content Adaptive Backlight Control, CABC, module adapted to stretch a histogram of the image, whereby a part of the plurality of pixels is brought into saturation, and, when the ambient light level is below a first threshold, adapted to decrease the stretching of the histogram. Thereby the part of the plurality of pixels brought into saturation is decreased and the quality of the image is improved.

### BRIEF DESCRIPTION OF THE DRAWINGS

Examples of embodiments herein are described in more detail with reference to attached drawings in which:

FIG. 1 show an electronic mobile device in accordance with embodiments herein.

FIG. 2 is a flow chart for methods described herein.

### DETAILED DESCRIPTION

As part of developing embodiments herein, a problem will first be discussed. To preserve full image quality, a histogram should not be stretched more than that the brightest pixel of the image reaches a value of 255 and becomes saturated. However, if a small amount of the pixels are allowed to be saturated, a significantly higher current reduction may be achieved with only a minor image quality impact. Allowing a part of the pixels to become saturated is known as aggressive CABC. A part of the histogram will represent pixels where the information will be lost due to saturation. The level of how many pixels that are allowed to be saturated may be tuned, and the tradeoff is current consumption versus image quality of the highlights of the image. Thus, the lightest parts of the image that will be lost due to saturation. The actual current save and image impact depends of how the histogram looks, which in turn depends on the image content. It should be noted that CABC, for a given image, saves a percentage of the backlight current consumption. As an example, using aggressive CABC for an image with a specific content saves 17%. Thus, if the current consumption without CABC is 100 mA, the save will be 17 mA. However, if the current consumption without CABC is 25 mA, the save will only be 4.3 mA. When CABC is tuned aggressively, the image impact will be the same in number of saturated pixels in bright and dark conditions even though the current save, in mA, will be very different. Since the display is dimmed in dark light conditions, the current save is smaller when measured in milliamps from the battery. The backlight current of the display, without CABC, is normally adapted to the ambient light level. As an example, the display brightness is typically 25% of max brightness in normal indoor conditions. Thus, when the ambient light is low, the backlight of the display is low and the current consumption of the display is therefore low from the beginning. If the histogram is still stretched and pixels are brought into saturation, and the backlight is further dimmed, the current to the display will indeed become lower; however, the actual amount of current saved will be low but still the image quality is lowered.

Embodiments herein will now be exemplified in the following detailed non-limiting description.

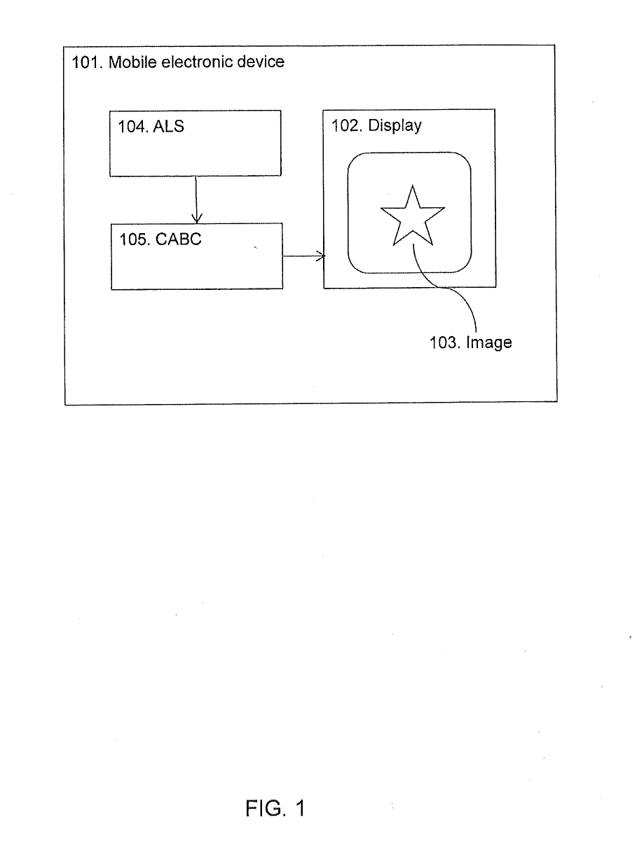

An electronic mobile device will now be described with reference to FIG. 1. Examples of such an electronic mobile device may be mobile telephones, smartphones, handheld computers, personal digital assistants, PDA, laptop, iPOD or iPAD.

The electronic mobile device 101 comprises at least one display 102 for showing an image 103. The display may be any display comprising a transflective or transmissive pixel matrix and a backlight. The display 102 may for example be a LCD. The content of the image 103 is shown on the display 102 by a plurality of pixels. The electronic mobile device 101 comprises further at least one ambient light level sensor, ALS, 104 adapted to establish a light level of light being ambient of the electronic mobile device 101. The ALS 104 may be any light level sensor suitable for use in an electronic mobile device. The at least one ALS 104 may further be adapted to establish the light level of light being ambient to the electronic mobile device 101 continuously. Further, the electronic mobile device comprises at least one CABC module 105 adapted to dynamically adapt a backlight luminance of the display 102 and adapted to stretch a histogram of the image 103. By the stretching, a part of the plurality of pixels is brought into saturation. When the ambient light level is below a first threshold, the CABC module 105 is adapted to decrease the stretching of the histogram. Thereby the part of the plurality of pixels brought into saturation is decreased and the quality of the image 103 is improved. This is advantageous since unnecessary poor quality of the image due to saturation is avoided. Especially in the situation where the backlight of the display is low at start, the current consumption save by stretching the image into saturation and further lowering the already low backlight of the display is low. The CABC, module 105 may be adapted to decrease the stretching of the histogram continuously based on continuously established level of light. By continuous adaption, the image quality will be preserved in a way that is transparent to a user of the device. Still further, small changes of the ambient light may still be utilized, resulting in a further improved way of saving current. When the ambient light level is below a second threshold, the CABC module 105 may be adapted to decrease the stretching of the histogram to 0%.

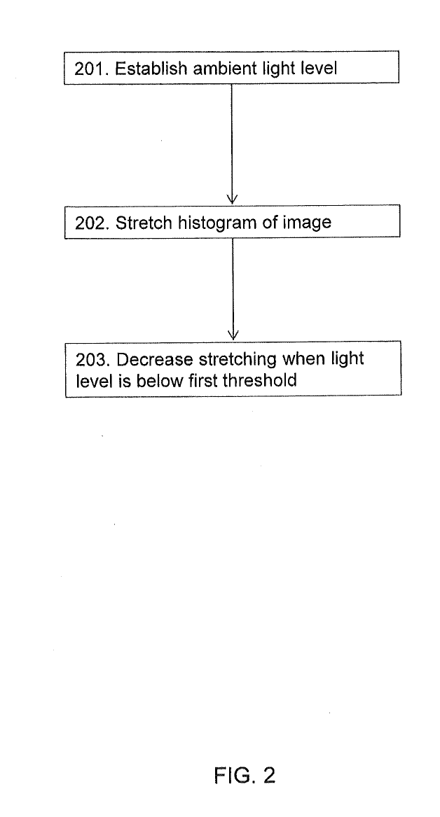

Example of embodiments of a method in the electronic mobile device will now be described with reference to a flowchart depicted in FIG. 2. As mentioned above, the mobile electronic device comprises at least one display for showing the image. The content of an image is shown on a display by a plurality of pixels. The method comprises the following actions, which actions may be taken in any suitable order.

Action 201

The electronic mobile device 101 is adapted to establish a light level of light being ambient of the electronic mobile device 101. Establishing the light level of light being ambient to the electronic mobile device 101 may be performed continuously.

Action 202

The electronic mobile device 101 stretches a histogram of the image 103, whereby a part of the plurality of pixels is brought into saturation. By stretching the image into saturation partly, the backlight of the display may be lowered even more with still a decent quality of the image remained. Thus, the current consumption of the display is lowered further.

Action 203

When the ambient light level is below a first threshold, the electronic mobile device 101 is further adapted to decrease the stretching 202 of the histogram, whereby the part of the plurality of pixels brought into saturation is decreased and the quality of the image is improved. Thus, unnecessary poor quality of the image due to saturation is avoided when the ambient light level is low and the current consumption of the backlight of the display is low. Decreasing the stretching 202 of the histogram may be performed continuously based on continuously established level of light. When the ambient light level is below a second threshold, the stretching 202 of the histogram may be decreased to 0%.

Thus, the tuning of the CABC is adapted with regards to an ambient light level. This is done by controlling the stretching, and thus the aggressiveness, of the CABC performance with regards to the ambient light level measured by the Ambient Light Sensor, ALS. Thereby, image quality artifacts caused by CABC algorithms will be minimized.

When using the word “comprise” or “comprising” it shall be interpreted as non-limiting, in the meaning of consist at least of.

When using the word action/actions it shall be interpreted broadly and not to imply that the actions have to be carried out in the order mentioned. Instead, the actions may be carried out in any suitable order other than the order mentioned. Further, some action/actions may be optional.

The embodiments herein are not limited to the above described examples. Various alternatives, modifications and equivalents may be used. Therefore, this disclosure should not be limited to the specific form set forth herein. This disclosure is limited only by the appended claims and other embodiments than the mentioned above are equally possible within the scope of the claims.

1. A method in an electronic mobile device for improving a quality of an image the electronic mobile device comprises at least one display for showing the image, the content of the image is shown on the display by a plurality of pixels,
the method comprises:
establishing an ambient light level that indicates a level of ambient light to the electronic mobile device,
stretching a histogram of the image, whereby a part of the plurality of pixels is brought into saturation, and
when the ambient light level is below a first threshold, decreasing the stretching of the histogram, whereby the part of the plurality of pixels brought into saturation is decreased and the quality of the image is improved.

2. The method according to claim 1, wherein establishing the ambient light level that indicates the level of ambient light to the electronic mobile device is performed continuously.

3. The method according to claim 2, wherein decreasing the stretching of the histogram is performed continuously based on the continuously established ambient light level.

4. The method according to claim 1, further comprising, when the ambient light level is below a second threshold, decreasing the stretching of the histogram to 0%.

5. The method according to claim 1, wherein the display is a Liquid Crystal Display, LCD.

6. An electronic mobile device adapted for improving a quality of an image, and comprising:
at least one display for showing the image, the content of the image is shown on the display by a plurality of pixels,
at least one ambient light level sensor, ALS adapted to establish an ambient light level that indicates a level of ambient light to the electronic mobile device, and
at least one Content Adaptive Backlight Control, CABC, module adapted to stretch a histogram of the image, whereby a part of the plurality of pixels is brought into saturation, and, when the ambient light level is below a first threshold, adapted to decrease the stretching of the histogram, whereby the part of the plurality of pixels brought into saturation is decreased and the quality of the image is improved.

7. The electronic mobile device according to claim 6, wherein the at least one ambient light level sensor, ALS is adapted to establish the ambient light level that indicates the level of ambient light to the electronic mobile device continuously.

8. The electronic mobile device according to claim 7, wherein the at least one Content Adaptive Backlight Control, CABC, module is adapted to decrease the stretching of the histogram continuously based on the continuously established ambient light level.

9. The electronic mobile device according to claim 5, wherein the at least one Content Adaptive Backlight Control, CABC, module is adapted to, when the ambient light level is below a second threshold, decrease the stretching of the histogram to 0%.

10. The electronic mobile device according to claim 5, wherein the display is a Liquid Crystal Display, LCD.
